(19) United States
(12) Patent Application Publication
(10) Pub. No.: US 2007/0248032 A1
(43) Pub. Date: Oct. 25, 2007

(54) Method of providing route update messages and paging access terminals

(76) Inventors: Subramanian Vasudevan, Morristown, NJ (US); Jialin Zou, Randolph, NJ (US)

Correspondence Address: WILLIAMS, MORGAN & AMERSON, 10333 RICHMOND, SUITE 1100, HOUSTON, TX, 77042, US

(21) Appl. No.: 11/409,491

(22) Filed: Apr. 21, 2006

(51) Int. Cl. H04J 3/08

(52) U.S. Cl. 370/315; 455/331

(57) ABSTRACT

The present invention provides a method for providing route update messages paging access terminals. The method may include providing at least one route update message based upon at least one travel pattern associated with an access terminal. The method may also include providing at least one page based on at least one previously received route update message and information indicative of at least one travel pattern.

### BACKGROUND OF THE INVENTION

1. Field of the Invention

This invention relates generally to communication systems, and, more particularly, to wireless communication systems.

2. Description of the Related Art

The coverage area of a wireless communication system is typically divided into a number of cells, which may be grouped into one or more networks. Access terminals located in each cell may access the wireless communications system by establishing a wireless communication link, often referred to as an air interface, with a base station associated with the cell. The access terminals may include devices such as mobile telephones, personal data assistants, smart phones, Global Positioning System devices, wireless network interface cards, desktop or laptop computers, and the like. As an access terminal moves between cells in the wireless communication system, the access terminal may periodically provide route update messages (also known as location update messages) that inform the wireless communication system of the access terminal's current location. Due to the mobility of the access terminal, the location of the cell where the most recent route update message was received is used to estimate the current location of the access terminal.

In some activity states, such as the idle or dormant mode or when the access terminal has been powered down, the access terminal may stop sending route update messages even though it may continue to move through the cells in the wireless communication system, until some condition is met (e.g., when the access terminal crosses the boundary of the sub-net associated with the last route update message, a new location update with the new sub-net is sent). Accordingly, the wireless communication system may not know which cell contains the access terminal when information becomes available for delivery to the access terminal. A wireless communication system may then attempt to reach the access terminal by sending paging messages over a plurality of cells belonging to a paging area determined by the network based on the information it has about the last known access terminal location, e.g., over the cells belonging to the last known sub-net. The paging messages contain information that indicates to the access terminal that information is available for transmission to the access terminal. If the access terminal receives the paging message, it may provide a paging response to a base station of a cell. The paging response typically indicates that the access terminal is available to receive the information and may also provide information indicating how to route the information to the access terminal.

Both the paging messages and the route update messages represent system overhead. Accordingly, the wireless communication system is generally designed to meet two conflicting objectives: reducing the overhead from the paging load and reducing the number of route update messages transmitted by the access terminal. The paging load is typically minimized when the location of the access terminal is known with relatively high accuracy so that each paging message can be transmitted to a relatively smaller number of cells. However, increasing the accuracy of the location of the access terminal requires transmitting a larger number of route update messages during a given period. In contrast, reducing the number of route update messages transmitted by the access terminal may reduce the accuracy of the access terminal location estimation by the wireless communication system, which typically results in each paging message being transmitted to a relatively large number of cells.

The conventional solution to this problem is to define sub-nets that include the cells serviced by a plurality of base stations. The access terminals may then transmit route update messages when they cross from one sub-net to another sub-net and the wireless communication system may begin the paging process by providing paging messages via the base stations in the sub-net indicated by the most recently received route update message. For example, the geographic area served by the wireless communication system may be divided up into multiple sub-nets that encompass the cells serviced by groups of 10 base stations. Access terminals in the wireless communication system may then provide location updates when they cross a cell boundary between the groups of 10 base stations and the wireless communication system may provide paging messages via the groups of 10 base stations in the sub-nets.

However, the number of users and the geographical area served by wireless communication systems is increasing, which results in an increase in the size and number of cells in a typical sub-net. Since conventional route update messages are triggered by crossing a sub-net boundary, access terminals may travel through numerous cells without providing any route update messages to the wireless communication system. Consequently, the wireless communication system may be required to provide paging messages to a large (and likely increasing) number of cells in order to locate the access terminal. The wireless communication system may therefore have to devote a larger percentage of system resources to supporting overhead associated with providing paging messages to large numbers of cells in the sub-nets.

One technique for reducing the number of cells that are paged is called radius-based paging. Radius-based paging techniques force the access terminal to provide a route update message when it travels a distance larger than a predetermined radius from a center of the cell where the access terminal was last seen. Alternatively, the access terminal may provide a route update message when it travels a distance larger than a predetermined radius from a group of cells covered by a radio network controller associated with the access terminal. The wireless communication system may then page the access terminal by providing a paging message to the cell where the access terminal was last seen. If the access terminal does not respond to this paging message, the wireless communication system may page the cells in the area defined by the predetermined radius. Paging messages may be provided to cells in increasingly large areas (indicated by increasingly large radii) if the access terminal fails to reply to a previous paging message.

Although radius-based paging may be preferable to subnet-based paging when the subnets include a large number of cells, radius-based paging still has a number of drawbacks. The system overhead associated with providing paging messages to all of the cells within the predetermined radius may consume a large percentage of the resources of the wireless communication system. The number of cells within a predetermined radius may be reduced by decreasing the radius, but this will result in an increase in the frequency of transmitting route update messages by the access terminal. Consequently, the system overhead associated with providing the route update messages may increase and consume a larger percentage of the resources of the wireless communication system. Power consumption by the access terminal may also be increased when the number of route update messages increases. Furthermore, relatively long paging delays may be experienced as the wireless communication system attempts to locate the access terminal in cells at increasing distances from the cell where the access terminal was last seen.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for providing route update messages. The method may include providing at least one route update message based upon at least one travel pattern associated with an access terminal. In another embodiment of the present invention, a method is provided for paging access terminals. The method may include providing at least one page based on at least one previously received route update message and information indicative of at least one travel pattern.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates a second exemplary embodiment of a wireless communication system, in accordance with the present invention;

FIG. 3 conceptually illustrates one exemplary embodiment of a method of providing route update messages, in accordance with the present invention;

FIG. 4 conceptually illustrates one exemplary embodiment of a method of paging an access terminal, in accordance with the present invention; and

FIG. 5 conceptually illustrates one embodiment of a method of determining a travel pattern at an access terminal, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

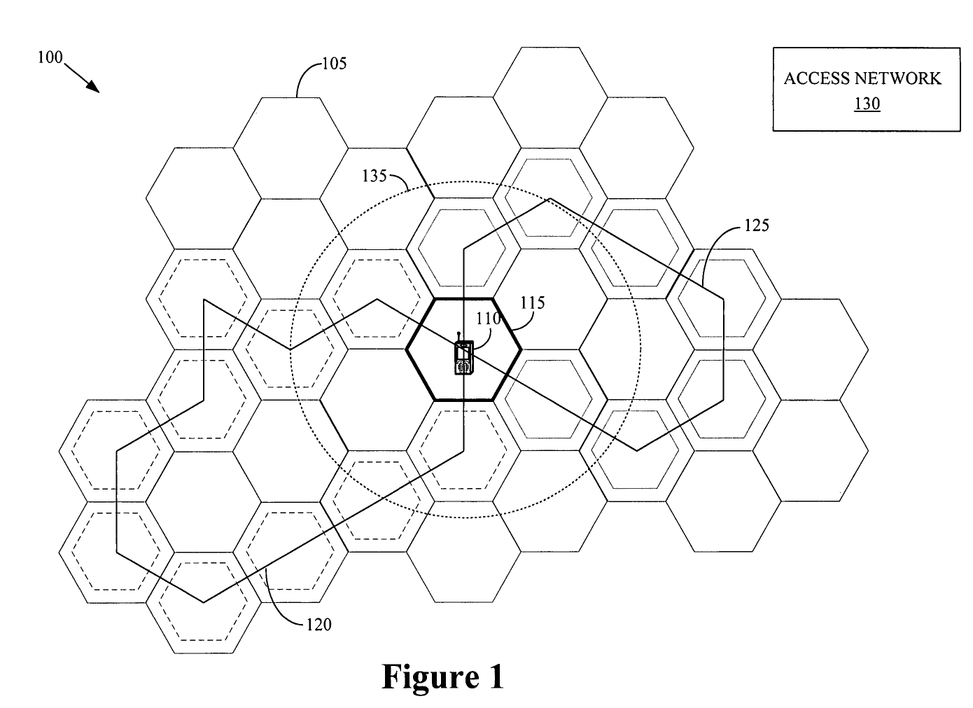

FIG. 1 conceptually illustrates a first exemplary embodiment of a wireless communication system 100. In the first exemplary embodiment, the wireless communication system 100 is configured to provide wireless connectivity to a plurality of geographic areas or cells 105 (only one indicated by the numeral 105). The wireless connectivity may be provided according to one or more standards or protocols such as the Universal Mobile Telecommunication System (UMTS), the Global System for Mobile communications (GSM), Code Division Multiple Access (CDMA, CDMA 2000), and the like. However, the particular standards, protocols, or combinations thereof are matters of design choice and not material to the present invention. Persons of ordinary skill in the art having benefit of the present disclosure should also appreciate that base stations, base station routers, and the like may be used to provide a wireless connectivity to the cells 105, although in the interest of clarity these devices are not shown in FIG. 1.

An access terminal 110 is deployed within the wireless communication system 100, which may provide wireless connectivity to the access terminal 110. Although a single access terminal 110 is shown in FIG. 1, persons of ordinary skill in the art having benefit of the present disclosure should appreciate that any number of access terminals 110 may be deployed in the wireless communication system 100. Persons of ordinary skill in the art should also appreciate that the access terminal 110 may also be referred to using terms such as “mobile unit,” “mobile station,” “user equipment,” “subscriber station,” “subscriber terminal,” and the like. Exemplary access terminals 110 include, but are not limited to, cellular telephones, personal data assistants, smart phones, pagers, text messaging devices, global positioning devices, network interface cards, notebook computers, and desktop computers. Techniques for configuring and/or operating the access terminal 110 are known in the art and in the interest of clarity only those aspects of configuring and/or operating the access terminal 110 that are relevant to the present invention will be discussed further herein.

One or more access networks 130 may be deployed within the wireless communication system 100. Although a single access network 130 is shown in FIG. 1, persons of ordinary skill in the art having benefit of the present disclosure should appreciate that any number of access networks may be deployed in the wireless communication system 100. Persons of ordinary skill in the art should also appreciate that the present invention is not limited to wireless communication systems that include access networks 130. In alternative embodiments, the wireless communication system may include other devices (such as radio network controllers) for connecting the cells to the wireless communication system 100. Techniques for configuring and/or operating the access networks 130 are known in the art and in the interest of clarity only those aspects of configuring and/or operating the access network 130 that are relevant to the present invention will be discussed further herein.

The access terminal 110 is configured to determine one or more travel patterns. As used herein, the term “travel pattern” will be understood to refer to one or more cells 105 that are selected based upon a usage pattern associated with the access terminal 110. In one embodiment, the travel pattern includes cells 105 that are likely to be visited by the access terminal 110 after leaving a primary cell (e.g., the cell that provides wireless connectivity to the access terminal when it is located in the user's home, workplace, or other location where the user may spend a large fraction of time) and before returning to the primary cell. For example, a particular user may leave home almost every Saturday morning and travel to the same soccer field, the same grocery store, the same restaurant or group of restaurants, one or more of a group of clothing stores, and then return home Saturday afternoon. Thus, one travel pattern associated with the access terminal 110 may include the cells 105 that provide wireless connectivity to areas that include the soccer field, the grocery store, the restaurants, and the clothing stores. Routes traveled by policemen, delivery trucks, mailmen, and the like may also be used to determine travel patterns. In some embodiments, the travel pattern may include a single cell 105. For example, primary cells where a user is likely to spend a large percentage of their time, e.g., home, work, and the like, are also considered travel patterns.

In the illustrated embodiment, the access terminal 110 is depicted in a primary cell 115. The access terminal 110 may on some occasions travel along a route 120 that may pass through a number of cells 105. Accordingly, the access terminal 110 may determine that a subset of the cells 105 (indicated by dashed hexagons) should be grouped into a travel pattern that includes the cells 105 that are likely to be visited by the access terminal 110 when traveling along the route 120. Similarly, the access terminal 110 may on other occasions travel along another route 125 and may therefore assign one or more of the cells 105 (indicated by dotted hexagons) as belonging to another travel pattern. The determined travel patterns may be stored in the access terminal 110 and/or provided to the access network 130. Techniques for determining the cells 105 that are included in the travel patterns will be discussed in more detail below.

The access terminal 110 is also configured to determine a likelihood that it is currently traveling along a route that may be associated with one or more of the determined travel patterns. For example, the access terminal 110 may determine that it is currently in one of the cells 105 in the travel pattern associated with the route 120, e.g., by comparing the current and/or previously visited cells to a stored travel pattern. The access terminal 110 may also determine that, since leaving the primary cell 115, it has visited a number of other cells 105 in the travel pattern associated with the route 120. Accordingly, the access terminal 110 determine that it is very likely that it is traveling along the route 120 or a similar route that may result in the access terminal 110 being present in one of the cells 105 associated with the travel pattern.

The access terminal 110 may determine whether or not to provide a route update message based on the travel patterns. As used herein, the term “route update message” will be understood to refer to any message that includes information that may be used to determine a location of the access terminal 110. In one embodiment, the access terminal 110 may not provide route update messages as long as it remains within one of the cells 105 in a travel pattern associated with the route 120. For example, the access terminal 110 may conventionally provide a route update message whenever it moves outside a circle 135 defined by a predetermined radius from the center of the primary cell 115. However, as long as the access terminal remains in one of the cells 105 in the travel pattern associated with the route 120, the access terminal 110 may not provide any route update messages. If the access terminal 110 enters a cell 105 that is not in the travel pattern associated with the route 120, the access terminal 110 may then provide a route update message to the access network 130.

The access terminal 110 may be paged using information indicative of the travel patterns. In one embodiment, a database including the cells in the travel patterns associated with each access terminal 110 is stored in the access network 130. For example, the database may be formed using information provided by the access terminal 110 when it determines one or more of the travel patterns. The access terminal 110 may also provide information indicating that it is currently traveling along a route that may be associated with one or more of a known travel patterns. For example, the access terminal 110 may send a message, such as a route update message, that includes an identification number indicating the current travel pattern. The access network 130 may then use the information indicative of the current travel pattern associated with the access terminal 110 to send a paging message via the cells 105 in the travel pattern.

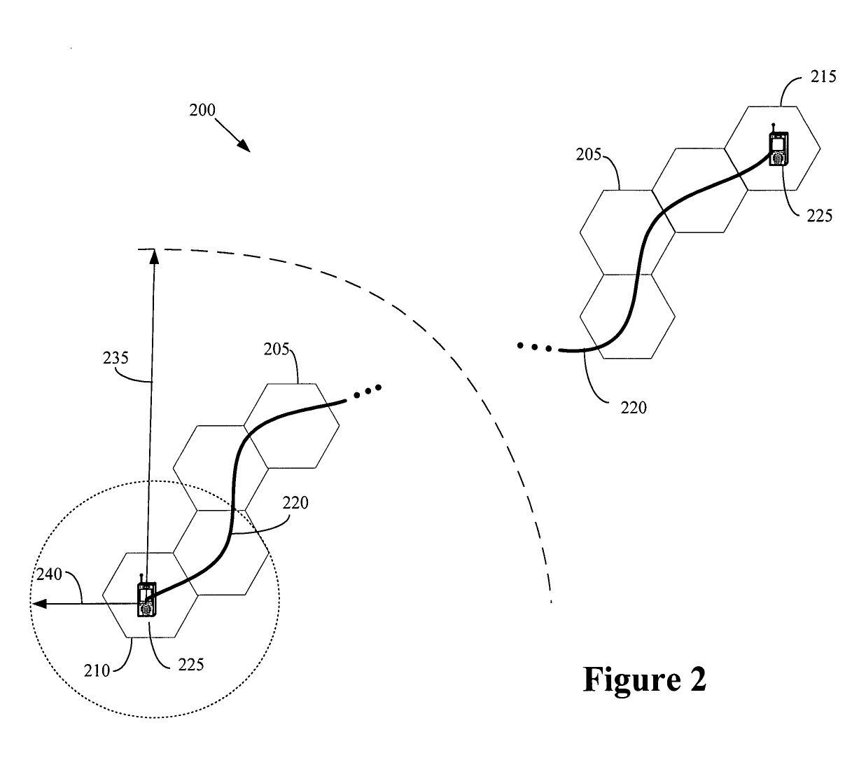

FIG. 2 conceptually illustrates a second exemplary embodiment of a wireless communication system 200. In the first exemplary embodiment, the wireless communication system 200 is configured to provide wireless connectivity to a plurality of geographic areas or cells 205 that include two primary cells 210, 215. For example, the primary cell 210 may provide wireless connectivity to a geographical area including a user's home and the primary cell 215 may provide wireless connectivity to a geographical area including the user's workplace. The cells 205 lie along a route 220 that corresponds to the user's commuting route from home to work and from work back to home. The user typically carries an access terminal 225 while commuting from home to work (and back) and so the access terminal 225 is able, over the course of time, to determine that the cells 205 that lie along the route 220 are part of a travel pattern. Information indicative of the travel pattern may be stored in the access terminal 225 and/or one or more access networks (not shown) associated with the cells 205, 210, 215.

When the user leaves the primary cell 210 and enters one of the cells 205 associated with the travel pattern, the access terminal 225 may determine that the cell 205 is associated with the travel pattern. The access terminal 225 may provide a route update message in response to leaving the primary cell 210. Information included in the route update message may indicate to the wireless communication system 200 that the access terminal 225 is most likely to be found in cells 205 associated with the travel pattern. If information destined for the access terminal 225 is received by the wireless communication system 200, then a paging message may be transmitted via the cells 205 in the travel pattern.

In some cases, the number of cells 205 in the travel pattern may be large. For example, the user may commute a relatively long distance through densely populated areas and so may pass through a relatively large number of cells 205 when traveling between the primary cell 210 and the primary cell 215. Thus, in some embodiments, the access terminal 225 may also use a distance traveled from one or more of the cells 205 to trigger transmission of a route update message. For example, the access terminal 225 may transmit the route update message when it has traveled a distance greater than the radius 235 from the primary cell 210, even though the access terminal 225 may still be traveling in cells 205 associated with the travel pattern. In one embodiment, the radius 235 may be selected to be larger than a radius 240 that is used for radius-based paging techniques when the access terminal 225 is not traveling along a known travel pattern. Persons of ordinary skill in the art having benefit of the present disclosure should appreciate that the particular values of the radii 235, 240 are matters of design choice and not material to the present invention.

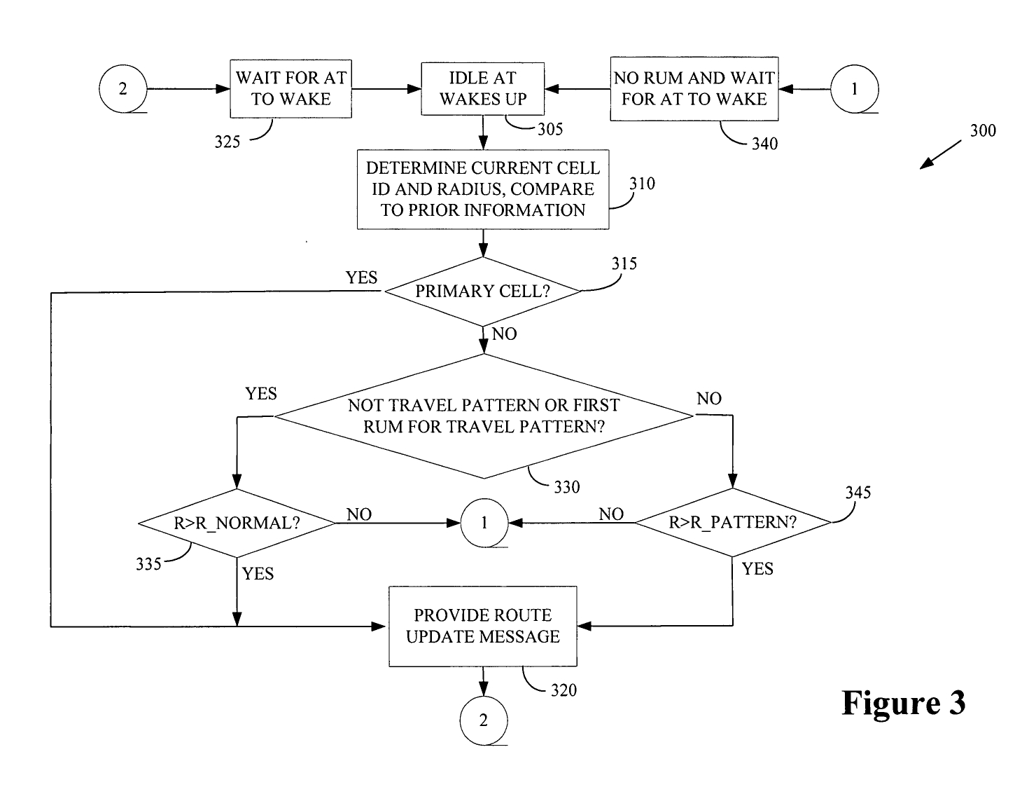

FIG. 3 conceptually illustrates one exemplary embodiment of a method 300 of providing route update messages. In the illustrated embodiment, an access terminal has determined one or more travel patterns, which include at least one primary cell. The travel patterns may also be stored in an access network, as discussed above. The access terminal is also assumed to have provided a previous route update message prior to entering the idle mode while in a cell that will be referred to as the last-RUM cell. In the illustrated embodiment, the access terminal is in an idle mode and then the idle access terminal wakes up (at 305). The access terminal may then determine (at 310) an identifier associated with the current cell and a radius from the current cell to the last-RUM cell. For example, the access terminal may receive a cell identifier by monitoring a broadcast channel and may use the identity of the cell to determine the radius from the current cell to the last-RUM cell. The access terminal may also compare (at 310) the current cell identifier and/or the radius to the prior information, e.g., the stored information indicating the primary cells and/or the travel patterns associated with the access terminal.

If the access terminal determines (at 315) that the current cell is a primary cell, then the access terminal may provide (at 320) a route update message. The route update message may include information identifying the primary cell as the current travel pattern and/or a default paging area. Once the route update message has been provided (at 320), the route update algorithm may wait (at 325) for the next time that the idle access terminal awakes. If the access terminal determines (at 315) that the current cell is not a primary cell, then the access terminal may determine (at 330) whether or not the current cell is a part of a known travel pattern. If the current cell is a part of a known travel pattern, the access terminal may also determine (at 330) whether or not a RUM for the known travel pattern was sent before. For example, the access terminal may compare the current cell (as well as other visited cells) to the cells in known travel patterns and may determine (at 330) whether or not the cells are likely to be part of one of the known travel patterns.

If the access terminal determines (at 330) that the current cell is not a part of a travel pattern, or if the current cell is part of a known travel pattern but no previous RUM has been transmitted for this pattern, then the access terminal may determine (at 335) whether or not the current radius from the last-RUM cell is larger than the radius (R_NORMAL) used in a conventional location-based paging scheme to determine whether or not to transmit a route update message. If the current radius is larger than R_NORMAL, then a route update message may be provided (at 320) and the algorithm may wait (at 325) for the next time the access terminal awakes. If the current radius is smaller than R_NORMAL, the access terminal does not transmit the route update message and simply waits (at 340) for the access terminal to awaken again.

In the illustrated embodiment, if the access terminal determines (at 330) that the current cell is a part of a travel pattern, then the access terminal may determine (at 345) whether or not the current radius from the last-RUM cell is larger than a radius (R_PATTERN) that is determined for the travel pattern and is larger than R_NORMAL. However, persons of ordinary skill in the art having benefit of the present disclosure should appreciate that the step of determining (at 345) whether or not the current radius from the last-RUM cell is larger than R_PATTERN is optional and not necessary for the practice of the present invention. If the current radius is larger than R_PATTERN, then a route update message may be provided (at 320) and the algorithm may wait (at 325) for the next time the access terminal awakes. If the current radius is smaller than R_PATTERN, the access terminal does not transmit the route update message and simply waits (at 340) for the access terminal to awaken again.

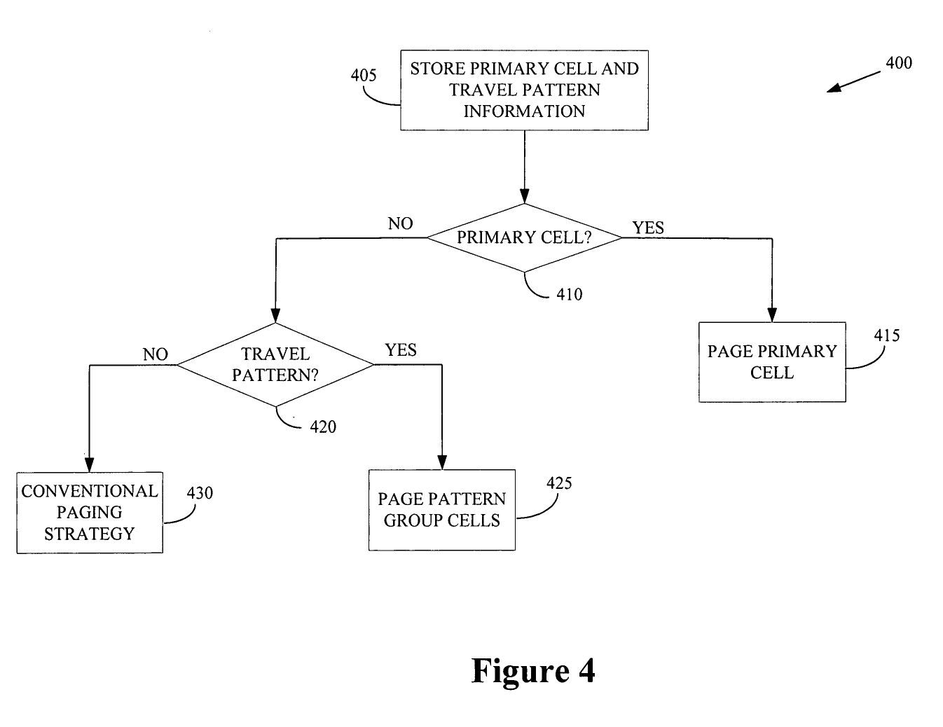

FIG. 4 conceptually illustrates one exemplary embodiment of a method 400 or paging access terminals based upon prior information associated with the access terminals. In the illustrated embodiment, an access network stores (at 405) prior information associated with the access terminals that indicates primary cells and/or travel patterns associated with the access terminals. As discussed above, this information may be provided by the access terminals and may be stored in a database that is accessible to the access network. If the access network wants to page the access terminal, the access network determines (at 410) whether or not the last-RUM cell for the access terminal was a primary cell. If the last-RUM cell is a primary cell, then the access network may page (at 415) the primary cell. If the last-RUM cell was not a primary cell, then the access network may determine (at 420) whether or not the last-RUM cell was a part of a travel patterns associated with the access terminal.

If the last-RUM cell is part of a travel pattern associated with the access terminal, then the access network may page (at 425) the cells that are part of the travel pattern. If the last-RUM cell was not part of one of the travel patterns associated with the access terminal, then the access network may page (at 430) using a conventional paging strategy, e.g., the access network may page a group of cells that are proximate to the last-RUM cell.

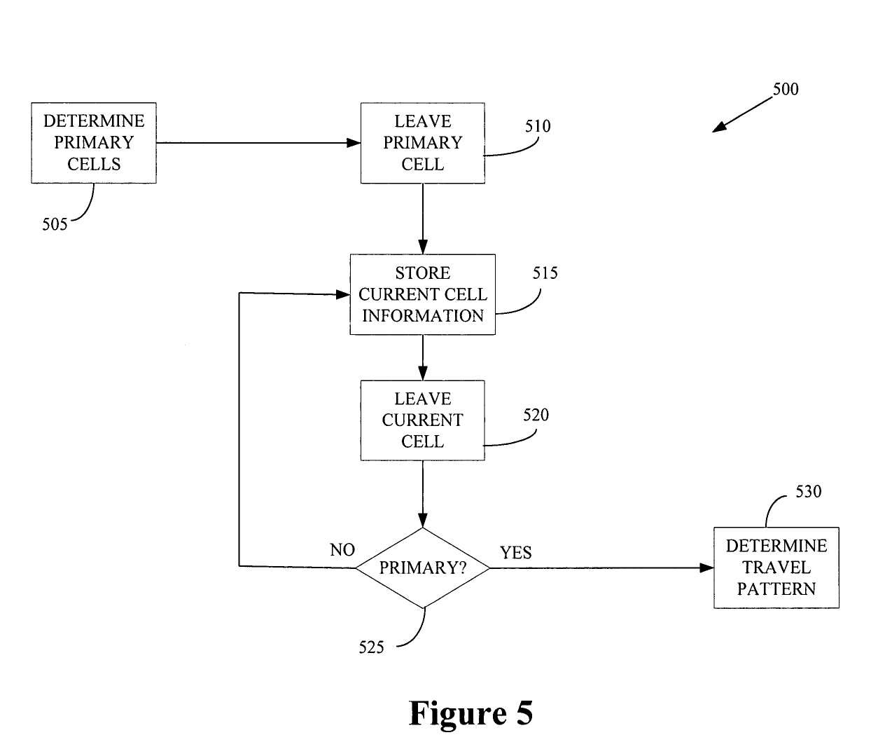

FIG. 5 conceptually illustrates one exemplary embodiment of the method 500 for determining a travel pattern at the access terminal. In the illustrated embodiment, one or more primary cells may be determined (at 505). For example, primary cells may be identified (at 505) based on addresses of cells that provide wireless connectivity/coverage to geographical areas including a user's primary stops, such as home, workplace, beach house, and the like. Information identifying the primary cells may be uploaded from the access terminal to an access network during initial call registration. In one embodiment, users may also create travel patterns based upon known or predetermined travel routes. For example, a police patrol route may be used to identify cells that provide wireless coverage along this route and the cells may be associated with a travel pattern. Information identifying the predetermined travel patterns may also be uploaded from the access terminal to the access network.

Once the user has registered the access terminal and begun to use the access terminal, the user is likely to travel outside of the primary cells. Travel outside of the primary cells is very likely to include travel routes that are repeated over time, which may allow the access terminal to determine travel routes including cells that will be repeatedly visited. Thus, when the user leaves (at 510) the primary cell, the access terminal may gather information indicative of one or more cells that are visited after the access terminal leaves (at 510) the primary cell. For example, the access terminal may gather cell identifiers. The information collected by the access terminal may be stored (at 515), e.g., in one or more memory elements within the access terminal. When the user leaves (at 520) the current cell, the access terminal may determine (at 525) whether or not the newly entered cell is one of the primary cells. If the new cell is not one of the primary cells, the access terminal may continue 5 to gather and store (at 515) information indicative of the cell. In one embodiment, the access terminal may maintain a cell appearance counter for all of the cells encountered by the access terminal and the cell appearance counter associated with the new cell may be incremented in response to determining that the new cell is not one of the primary cells.

If the newly entered cell is determined (at 525) to be one of the primary cells, the access terminal may determine that the current trip (i.e., the trip from the primary cell two other non-primary cells and back to the primary cell) is complete. In one embodiment the access terminal may maintain a trip counter that indicates the number of round trips completed by the access terminal. Accordingly, the access terminal may increment the trip counter in response to determining (at 525) that the new cell is a primary cell. The access terminal may use the information associated with the cells visited between the time the access terminal left (at 510) the primary cell and the time the access terminal returned (at 525) to one of the primary cells to determine (at 530) one or more travel patterns. For example, the access terminal may compute the ratio of the cell appearance counter of a cell to the number of trips taken by the access terminal. When this ratio is relatively large for a particular cell, the cell is likely to be part of one or more travel patterns because it is visited relatively often.

In one embodiment, the access terminal may determine (at 530) the travel pattern by further dividing a selected number of the most-frequently-visited cells into one or more travel patterns. For example, the access terminal may assign all of the cells encountered during the first trip to a first travel pattern. If more than 50% of the cells encountered in a second trip do not belong to the first travel pattern, then the cells encountered in the second trip may be assigned to a second travel pattern group. However, if most of the cells encountered belong to the first travel pattern, then the cells in this trip may be associated with the first travel pattern. This procedure may be repeated for subsequent trips taken by the access terminal. Over time, as the access terminal takes more trips and visits more cells, the number of travel patterns may increase and the statistics available for associating cells with each travel pattern may improve. Thus, other techniques for associating cells with travel patterns may be employed.

In one embodiment, correlations of cells to a travel pattern may be determined (at 530) using a correlation metric. For example, a correlation metric of a cell i to a travel pattern j may be set equal to a ratio of the aggregate number of appearances of the cell i in trips which have been associated with the travel pattern j to the aggregate number of trips that have been associated with the travel pattern j. Each time a trip associated with a particular travel pattern has completed, information associated with the cells that appeared in the most recent trip may be combined with previously acquired information associated with cells visited during previous trips and this information may be used to update the correlation metrics associated with each cell in the travel pattern.

Membership of the cells in the travel pattern(s) may be determined based on the correlation metric. For example, if a correlation metric of a particular cell falls below a predetermined value, the cell may be removed from the travel pattern. However, persons of ordinary skill in the art having benefit of the present disclosure should appreciate that other statistics may also be used to determine membership in a traffic pattern. For example, statistics may be selected or defined to a probability that a cell in a travel pattern has been visited by the access terminal. The cell and/or the associated travel pattern may be dropped, e.g., from the access terminal's database, if the probability that a cell has been visited is less than a pre-determined threshold over certain age. Cells and/or the associated travel patterns with high visited probabilities may be uploaded to access network and used for route update and paging.

Embodiments of the techniques described above may have a number of advantages over conventional practice. Since the access terminals may only provide route update messages when entering cells that are not in known travel patterns, the signaling overhead associated with providing these route update messages may be reduced. Power consumption by the access terminals may also be reduced by providing route update messages when the access terminal enters a cell that is not in a known travel pattern. The number of cells that may be paged by a wireless communication system attempting to locate an access terminal may also be reduced because the wireless communication system may initially page cells in one of the known travel patterns. Paging delays may also be reduced, which is particularly important for and delay sensitive applications.

The access terminal may also create more accurate travel patterns and identify these travel patterns in a more efficient manner than other entities in the wireless communication system. For example, access terminals typically conduct wake-up activities more often than they send route update messages. The access terminal may therefore collect statistics associated with travel patterns more frequently than is possible at locations outside the access terminal, at least in part because locations outside the access terminal only receive location information in the route update messages.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
providing at least one route update message based upon at least one travel pattern associated with an access terminal.

2. The method of claim 1, wherein providing said at least one route update message comprises associating the access terminal with said at least one travel pattern.

3. The method of claim 2, wherein associating the access terminal with said at least one travel pattern comprises associating the access terminal with said at least one travel pattern based on at least one cell visited by the access terminal.

4. The method of claim 1, wherein providing said at least one route update message comprises providing at least one route update message in response to the access terminal entering at least one cell not included in said at least one travel pattern.

5. The method of claim 1, wherein providing said at least one route update message comprises providing at least one route update message in response to the access terminal entering at least one cell included in said at least one travel pattern when a route update message associated with said at least one travel pattern has not been provided.

6. The method of claim 1, comprising providing at least one route update message in response to the access terminal entering at least one cell that is further than a predetermined radius from a cell received a previous route update message.

7. The method of claim 1, comprising determining, at the access terminal, said at least one travel pattern.

8. The method of claim 7, wherein determining said at least one travel pattern comprises determining at least one primary cell based on at least one likelihood that the access terminal is present in said at least one primary cell.

9. The method of claim 8, wherein determining said at least one travel pattern comprises determining at least one cell visited by the access terminal after leaving said at least one primary cell and until returning to said at least one primary cell.

10. The method of claim 9, wherein determining said at least one travel pattern comprises associating said at least one cell with said at least one travel pattern based on a correlation metric.

11. The method of claim 7, comprising providing information indicative of said at least one travel pattern to at least one access network.

12. The method of claim 7, comprising dropping at least one of a cell and a travel pattern based on a probability the cell or travel pattern has been visited by an access terminal.

13. The method of claim 1, comprising receiving at least one paging message broadcast to cells associated with said at least one travel pattern.

14. A method, comprising:
receiving at least one route update message that is provided based upon at least one travel pattern associated with an access terminal.

15. The method of claim 14, wherein receiving said at least one route update message based upon said at least one travel pattern comprises receiving said at least one route update message transmitted based upon at least one travel pattern associated with the access terminal based on at least one cell visited by the access terminal.

16. The method of claim 14, wherein receiving said at least one route update message comprises receiving at least one route update message in response to the access terminal entering at least one cell not included in said at least one travel pattern.

17. The method of claim 14, wherein receiving said at least one route update message comprises receiving at least one route update message in response to the access terminal entering at least one cell included in said at least one travel pattern when a route update message associated with said at least one travel pattern has not been provided.

18. The method of claim 14, comprising receiving at least one route update message in response to the access terminal entering at least one cell that is further than a predetermined radius from a cell received the last route update message.

19. The method of claim 14, wherein receiving said at least one route update message based upon said at least one travel pattern comprises receiving said at least one route update message based upon at least one travel pattern determined at the access terminal.

20. The method of claim 14, comprising receiving information indicative of said at least one travel pattern.

21. The method of claim 14, comprising receiving information that at least one of a cell and a travel pattern should be dropped based on a probability the cell or travel pattern has been visited by an access terminal.

22. The method of claim 14, comprising providing at least one paging message to cells associated with said at least one travel pattern.

23. A method, comprising:
providing at least one page based on at least one previously received route update message and information indicative of at least one travel pattern.

24. The method of claim 23, wherein providing said at least page comprises providing said at least one page intended for an access terminal based upon a route update message received from the access terminal and at least one travel pattern associated with the access terminal.

25. The method of claim 23, wherein providing said at least one page comprises providing said at least one page to at least one cell in said at least one travel pattern.

26. The method of claim 25, wherein providing said at least one page to at least one cell in said at least one travel pattern comprises providing said at least one page to at least one cell in said at least one travel pattern in response to determining that the previously received route update message was received at a cell included in said at least one travel pattern.

27. The method of claim 23, wherein providing said at least one page comprises providing said at least one page to at least one primary cell.

28. The method of claim 27, wherein providing said at least one page to at least one primary cell comprises providing said at least one page to said at least one primary cell in response to determining that the previously received route update message was received at the primary cell.
